(19) United States
(12) Patent Application Publication
(10) Pub. No.: US 2004/0195471 A1
(43) Pub. Date: Oct. 7, 2004

(54) Dual flat panel monitor stand

(76) Inventor: Richard John Sachen JR., Mountain View, CA (US)

Correspondence Address: RICHARD JOHN SACHEN, JR., 471 CENTRAL AVENUE, MOUNTAIN VIEW, CA, 94043, US

(21) Appl. No.: 10/755,192

(22) Filed: Jan. 9, 2004

Related U.S. Application Data
(60) Provisional application No. 60/439,324, filed on Jan. 9, 2003.

(51) Int. Cl. F16M 11/00

(52) U.S. Cl. 248/127; 248/917

(57) ABSTRACT

The invention is a dual flat panel monitor stand, hinged so that the monitors can be viewed side-by-side, back-to-back, or any angle in between. The hinge is a unique compound hinge designed to allow maximum flexibility while using the minimum amount of space. The hinge is mounted on a turntable that allows the whole unit to rotate 360 degrees. The stand also includes electrical support in the base so that only the minimum number of external wires is required. The electrical support in the stand can include a video switch, video enhancement hardware, and/or a multi-function computing device.

### CROSS-REFERENCE TO RELATED APPLICATIONS

Provisional Application No. 60/439,324 filed Jan. 9, 2003

### STATEMENT REGARDING FEDERALLY SPONSORED RESEARCH OR DEVELOPMENT

Not applicable.

### REFERENCE TO SEQUENCE LISTING, TABLE, OR COMPUTER PROGRAM LISTING

Not Applicable

### BACKGROUND OF THE INVENTION

The invention relates to an assembly for supporting computer monitors that adjusts vertically, pivots, tilts forward and back, and folds upon itself for side-to-side or back-to-back viewing.

Dual monitor computing has been available for many years. Initially, this was little used due to the desk space required for two CRT monitors. With the introduction of the LCD screen, space requirements have considerably reduced and several multiple monitor stands have been invented. Multiple monitor solutions are becoming more popular as the cost of LCD, video cards, and computers declines while the power increases. Specialized financial, security, and graphics users have been the first to embrace the usefulness of multiple monitors.

Several Multiple Monitor Stand inventions are fixed stands that hold two monitors side-by-side or Top-to-Bottom with limited adjustments for vertical, tilt, or pivoting motion. U.S. Pat. No. RE 36,978, Dec. 5, 2000, U.S. Pat. No. 5,687,939 Nov. 18, 1997, and U.S. Pat. No. 5,904,328 May 18, 1999, U.S. Pat. No. D 438,206 Feb. 27, 2001; U.S. Pat. No. D 395,041 Jun. 9, 1998 are examples of stands primarily designed to maximize viewing by a single user. These stands have their use, but do not provide the versatility to allow multiple users to view the screens. U.S. Pat. No. 5,594,620 Jan. 14, 1997; U.S. Pat. No. 5,590,021 Dec. 31, 1996; U.S. Pat. No. 5,673,170 Sep. 30, 1997 provide ameans of attaching or supporting a secondary monitor to a primary monitor for a dual setup. While this is good for upgrades, it lacks the aesthetic qualities and easy of use that a dedicated monitor stand provides. Design U.S. Pat. No. D 436,354 Jan. 16, 2001 is a fixed side-by-side display console with ergonomic control console without hinges for single or two users side-by-side, lacking the flexibility of a hinged stand.

Several solutions have been developed for multiple-monitors in 2, 3, 4, 5 or more monitors per stand. patent application Ser. No. 10/197,377 Jul. 17, 2002 is an example of one of those. It has an articulating arm that can be adjusted for multiple user support or single user support. The articulating arms allow a wide scope for adjustment, but because they are independent and widely adjustable, they cannot be quickly folded back-to-back or pivoted as a unit. The also take up a lot of space or require special mounting to prevent the stand from tipping. U.S. Pat. No. 6,343,006 Jan. 29, 2002 in its primary manifestation is developed for the single user. Several alternate manifestations are designed for multiple user or single user use. The examples all have a hinge located at the edges of the two monitors allowing them to fold like a book. While similar in result, the edge located hinge requires the monitors to fold along a radius equal to the width of the monitor thus taking up a lot of space or requiring the user to lift the monitors when switching modes. Several hinged dual monitor stands have been designed, U.S. Pat. No. D 425,036 May 16, 2000; U.S. Pat. No. D 395,298 Jun. 16, 1998 have two LCD monitors supported at the outer edge with either a single or dual pole support. These are designed to be permanently mounted on a desktop and have the disadvantage of making the monitors swing through a radius equal to the width of the monitor. The monitors on the single pole interfere with each other when in back-to-back mode. The double pole version only allows a back-to-back configuration at an angle 90 degrees from the side-by-side position.

Several hinged monitor solutions have been proposed for laptops that allow single and multiple user use. U.S. Pat. No. 6,532,146 Mar. 11, 2003; U.S. Pat. No. 6,498,721 Dec. 24, 2002; U.S. Pat. No. 6,094,341 Jul. 25, 2000; U.S. Pat. No. 6,504,706 B2 Jan. 7, 2003; and patent applications Ser. No. 10/58,754 Jan. 30, 2002; Ser. No. 09/683,724 Feb. 7, 2002; Ser. No. 09/989,951 Nov. 20, 2001; Ser. No. 09/781,711 Feb. 12, 2001 are all examples of laptop designs that include an edge hinged secondary monitor for presentation and expanded viewing. These solutions require a space equal to the width or height of the monitors in order to swing out the secondary monitor for viewing. patent applications Ser. No. 10/082,058 Feb. 26, 2002 and Ser. No. 09/858,520 May 17, 2001 both have a single central pivot for sharing data by pivoting the monitor back and forth. The obvious disadvantage of this solution is that only one person can view the monitor at a time. patent application Ser. No. 09/862,671 May 22, 2001 also has a pivoting main display, but with a fixed secondary display placed next to the keyboard. While this allows the presenter to see what is displayed on the primary monitor, the small size is a disadvantage when doing single-user work. U.S. Pat. No. 6,295,038 B1 Sep. 25, 2001 has a laptop dual monitor solution with a slide out second display for dual monitor use by a single user, lacking the flexibility to support multiple users. U.S. Pat. No. 5,534,888 Jul. 9, 1996 is similar to several of the dual screen notebook ideas, but with multiple displays set in a book format designed for easy use by a single user rather than multiple users.

U.S. Pat. No. 5,856,819 Jan. 5, 1999 is for a fixed back-to-back LCD display system. This is good for presentation and viewing by multiple users, but does not have the flexibility of a dual side-by-side monitor solution.

There are also quite a few patents relating to single stand solutions that cover a variety of pivoting and adjustments. None cover the specific dual monitor stand or the combinations of hinges, bearings, bushings, or pivots claimed in this patent. Several include power and signal cable management, but none have the unique power distribution or signal enhancement or splitting circuitry claimed in this patent. U.S. Pat. No. 4,690,362 Sep. 1, 1987 relates to an adjustable height stand raised and lowered with a helical drive gear, which is not part of this patent claim. U.S. Pat. No. 6,484,994 B2, Nov. 26, 2002; U.S. Pat. No. 6,050,535 Apr. 18, 2000; U.S. Pat. No. 6,536,721 Mar. 25, 2003; U.S. Pat. No. 6,595,481 Jul. 22, 2003; U.S. Pat. No. 6,581,893 Jun. 24, 2003; U.S. Pat. No. 6,032,918 Mar. 7, 2000 and patent applications Ser. No. 10/184,978 Jul. 1, 2002; Ser. No. 09/815,691 Mar. 23, 2001; Ser. No. 10/197,333 Jul. 18, 2002; Ser. No. 10/036,114 Oct. 19, 2001 relate to single monitor LCD stands.

In the current state of the art, no stand provides a compact, easy to adjust dual monitor stand that allows the monitors to fold side-by-side, back-to-back, or any angle in between. In addition, while cable routing has been addressed in several stands, no stand incorporates video switching, amplification, or power distribution from single input to multiple outputs. These features are unique to the stand invented here.

### BRIEF SUMMARY OF THE INVENTION

The invention is a dual flat panel monitor stand, hinged so that the monitors can be viewed side-by-side, back-to-back, or any angle in between. The hinge is a unique compound hinge designed to allow maximum flexibility while using the minimum amount of space. The hinge is mounted on a turntable that allows the whole unit to rotate 360 degrees. The stand also includes electrical support in the base so that only the minimum number of external wires is required. The electrical support in the preferred embodiment can include a video switch and video enhancement hardware.

### BRIEF DESCRIPTION OF THE SEVERAL VIEWS OF THE DRAWING

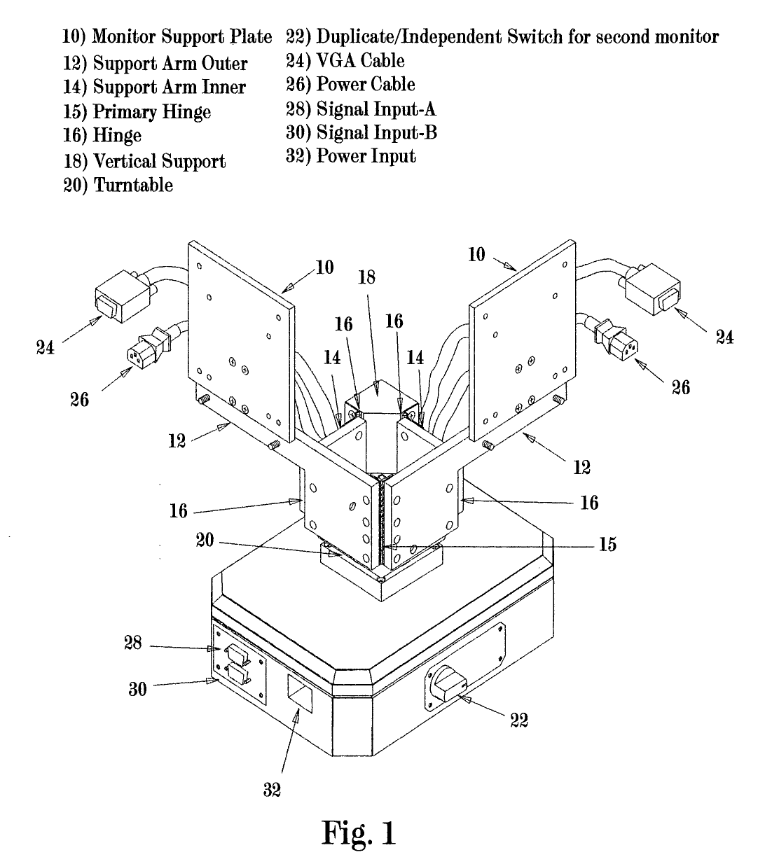

A) FIG. 1—Isometric View showing front of Invention

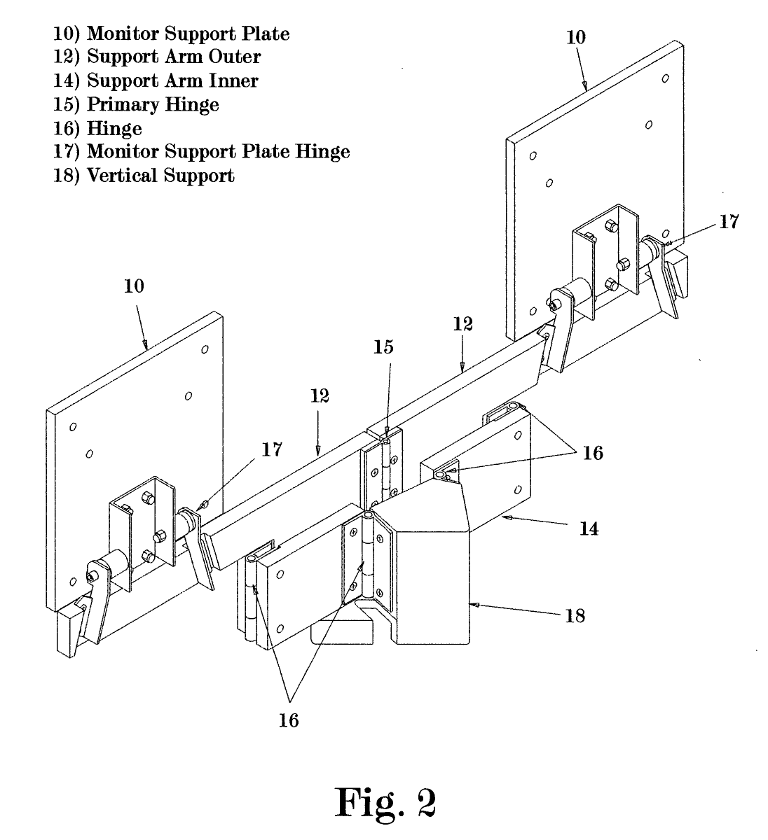

B) FIG. 2—Isometric View showing hinge mechanism open

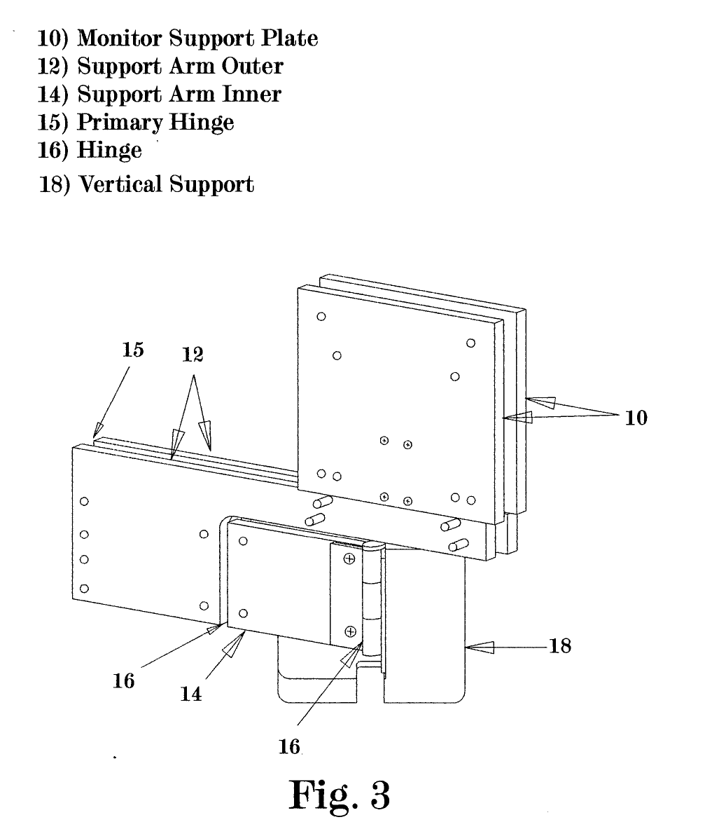

C) FIG. 3—Isometric View showing hinge mechanism closed

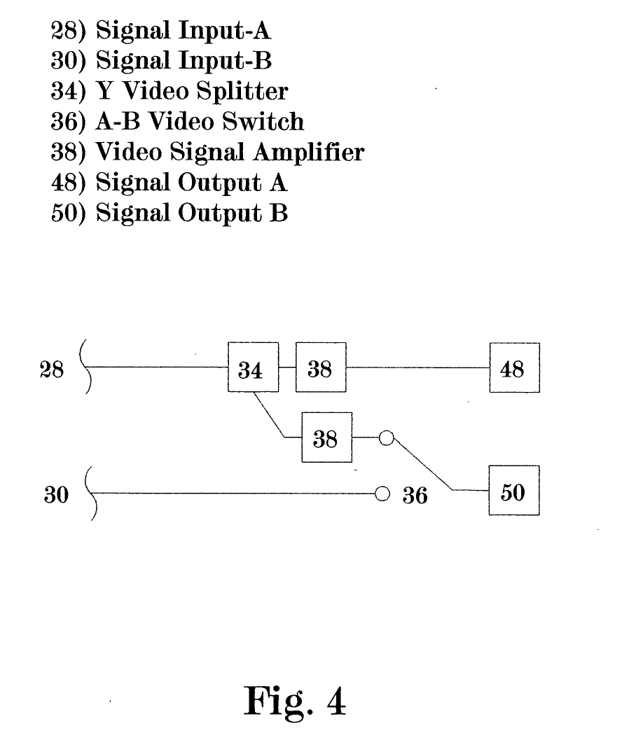

D) FIG. 4—Electrical diagram

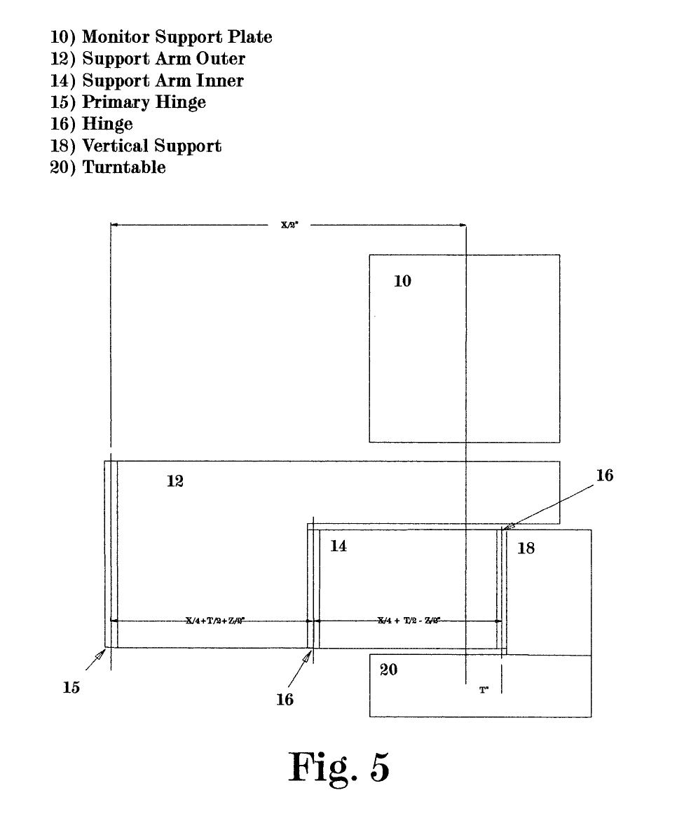

E) FIG. 5—View showing dimensional relationships between critical hinge pieces.

### LIST OF REFERENCE NUMERALS FOR DRAWINGS

10) Monitor Support Plate

12) Support Arm Outer

14) Support Arm Inner

15) Primary Hinge

16) Hinge

17) Monitor Support Plate Hinge

18) Vertical Support

20) Turntable

22) Duplicate/Independent switch for second monitor

24) VGA Cable

26) Power Cable

28) Signal Input-A

30) Signal Input-B

32) Power input

34) Y video splitter

36) A-B video switch

38) Video signal amplifier

40) Sleeve

42) Spring

44) Lock Nut

46) Channel

48) Signal Output A

50) Signal Output B

### DETAILED DESCRIPTION OF THE INVENTION

Reference will now be made in detail to the present preferred embodiment of the present invention, examples of which are illustrated in the accompanying drawings, wherein like reference numerals refer to the like elements throughout. The embodiment is described below in order to explain the present invention by referring to the figures.

FIG. 1 shows the preferred embodiment of the complete invention. Two monitor support plates (10) are used to support LCD monitors, the support plates attach to an outer support arm (12) hinged (16) to an inner support arm (14), which is hinged (16) to a vertical support (18). The vertical support is attached to a turntable (20). The turntable has holes to allow video and power cables to come up from the base and attach to the LCD monitors when they are in place. FIG. 2 and 3 show the arrangement of the inner and outer support arms, hinges and vertical support in open and closed positions. FIG. 4 shows an electrical diagram showing the video splitter (34), switch (36) used in alternate form A, and signal amplifier (38) that is located in the base.

FIG. 5 shows the dimensional relationships between the various parts of the compound hinge. Determining the relationship between the various parts of the compound is based on knowing the following critical factors:

X=the maximum width of the monitor case to be supported

T=the offset from the turntable centerline - this determined based on the cantilever strength of the hinge and turntable on the one hand or the size of the base required to prevent tipping on the other. The larger T is, the closer the center of gravity moves to the turntable centerline.

Z=the total width of the support structure consisting of the assembled Monitor Support Plate (10), Support Arm Outer (12), Support Arm Inner (14), Primary Hinge (15), Hinges (16), and Monitor Support Plate Hinge (17)

The distance from the centerline of the Monitor Support Plate (10) to the centerline of the Primary Hinge (15)=X/2

The distance from the Primary Hinge (15) to the Hinge (16) between the Support Arm Outer (12) and Support Arm Inner (14)=X/4+T/2+Z/2 The distance from the Hinge (16) between the Support Arm Outer (12) and Support Arm Inner (14) and the Hinge (16) between the Support Arm Inner (14) and the Vertical Support (18)=X/4+T/2−Z/2

The distance between the outside edge of the Support Arm Outer (12) and the centerline of the Primary Hinge (15)=Z/2

The distance between the two hinges (16) on the Vertical Support (18)=Z

In the invention's main form, two LCD monitors are attached to the monitor support plates. The video and power cables are plugged into the monitors. External power is supplied by plugging a power source into the power input (32) and then plugging the video input from one or two compatible video source(s) such as from a computer, completes the set-up. By turning on a video source and the monitors, the user can view one or two video outputs using the duplicate/independent video switch.

It will be appreciated that particular embodiments of the invention have been described and that modifications may be made therein without departing from the spirit of the invention or necessarily departing from the scope of the appended claims.

What I claim as my invention is:

1. A dual LCD monitor stand that consists of
A mounting plate to support LCD monitors.
A hinge connecting the mounting plate to the support arm allowing the mounting plate to be adjusted from the vertical.
A compound hinge that allows the monitors to fold from side-by-side to back-to-back orientation in a small space.
A turntable for allowing the compound hinge to rotate 360 degrees.
Internal electronics to provide power, boost the signal, and/or switch input from one or more video sources into each or both displays.
A base to hold said electronics that also supports the structure without tipping.

2. The dual LCD monitor stand in 1 with switch, splitter and amplification circuits removed allowing for two inputs to produce independent images on two monitors

3. The dual LCD monitor stand in 1 with the switch and second input removed allowing for one input to produce a duplicate image on two monitors.

4. The dual LCD monitor stand in 1 in which the internal electronics include a multi-function computing device.
